(19) United States
(12) Patent Application Publication
(10) Pub. No.: US 2009/0022993 A1
(43) Pub. Date: Jan. 22, 2009

(54) Copper alloy

(75) Inventors: Yasutaka Sugawara, Hitachi-shi (JP); Kazuhiko Fukamachi, Hitachi-shi (JP)

Correspondence Address: OLIFF & BERRIDGE, PLC, P.O. BOX 320850, ALEXANDRIA, VA, 22320-4850, US

(73) Assignee: NIPPON MINING & METALS CO., LTD, Tokyo (JP)

(21) Appl. No.: 12/071,666

(22) Filed: Feb. 25, 2008

Related U.S. Application Data
(63) Continuation of application No. 10/722,428, filed on Nov. 28, 2003, now abandoned.

(30) Foreign Application Priority Data
Nov. 29, 2002 (JP) 2002-346979

(51) Int. Cl. B32B 5/16

(52) U.S. Cl. 428/402

(57) ABSTRACT

Copper alloys having excellent strength while suppressing irregularity of wavelengths, etc., of the fluctuations and having excellent bendability are obtained while suppressing growth of crystal grains. The copper-based alloy contains 2.0 to 4.0 mass % of Ti, and the total content of unavoidable impurity elements Pb, Sn, Zn, Mn, Fe, Co, Ni, S, Si, Al, P, As, Se, Te, Sb, Bi, Au, and Ag is not more than 0.1 mass %, and contents of each element thereof is not more than 0.01 mass %, and not less than 80% of quality of a second-phase particles having an area of not less than 0.01 μm² observed by a cross section speculum contains not less than 3% of the total amount of the above described unavoidable impurity elements in composition.

This is a Continuation of application Ser. No. 10/722,428 filed Nov. 28, 2003. The entire disclosure of the prior application is hereby incorporated by reference herein in its entirety.

### BACKGROUND OF THE INVENTION

1. Field of the Invention

The present invention relates to a copper alloy for use as a connector material, etc. and more particularly, the present invention relates to a copper alloy in which excellent strength and bendability are obtained simultaneously.

2. Description of Related Art

A copper alloy that contains titanium (hereinafter called “titanium-copper”) may be used as a connector material, etc., and recent years, the demands thereon have tended to increase. In order to cope with this trend, various research and development concerning precipitation hardening of the titanium-copper has been performed. In conventional titanium-copper, in some cases, for example, Ni and Al are added (for example, see Japanese Laid-Open Patent Publication No. SHO 50-53228 (pages 1 and 2)), in other cases, Al and Mg are added (for example, see Japanese Laid-Open Patent Publication No. SHO 50-110927 (pages 1 and 2)), and in other cases, Sn, Ni and Co are added (for example, see Japanese Laid-Open Patent Publication No. SHO 61-223147 (pages 1 to 3)). In addition, in recent years, copper alloys to which Cr, Zr, Ni, and Fe are added has been proposed (for example, see Japanese Laid-Open Patent Publication No. HEI 6-248375 pages 2 to 8)). Moreover, a technique relating to refined crystal grains is proposed (for example, see Japanese Laid-Open Patent Publication No. 2001-303158 (pages 2 to 4)).

From the titanium-copper, a supersaturated solid solution is generated by solution treatment when it is subjected to aging from this state, and a modulated structure in a metastable phase develops from the initial state, and it stiffens remarkably at a certain time during development. This modulated structure of the titanium-copper depends on fluctuations in the titanium content of solid solution generated in the matrix. However, in the case in which elements other than copper and titanium are contained, in spite of common level of impurities, these elements enter into a solid solution within the matrix, so that irregularities occur in the wavelengths or amplitudes of the above-described fluctuations, resulting in deterioration of age-hardenability. Consequently, there was a problem in that superior strength (for example, yield strength) which could be obtained originally could not be obtained. Furthermore, in a large number of conventional techniques, in which third elements are deliberately added, a large adverse effect occurred, and there was no improvement in strength while maintaining the original age-hardenability and ductility of the titanium-copper. For that reason, it is desired to develop a copper alloy with superior strength while suppressing irregularities of wavelengths, etc., of the above-described fluctuations.

In addition, when the crystal grains are refined in the final recrystallization annealing, the yield strength is improved; however, in the general manufacturing process of the titanium-copper, the solution treatment corresponds to the final recrystallization annealing, and this thermal treatment is executed at a temperature at which the titanium solves into matrix sufficiently, so that crystal grains are easy to grow at such a temperature. For that reason, in order to obtain yield strength improvement by refining the crystal grains, the solution treatment should be performed at a lower temperature. Consequently, when refining the crystal grains of the titanium-copper by conventional techniques, the titanium does not solve into matrix sufficiently, so that TiCu₃ as a stable phase is precipitated. There was the problem in that the TiCu₃ precipitated at the crystal grain boundary at the time of this solution treatment not only does not contribute to hardening at the aging in the later process, but also bendability deteriorates. For this reason, there is desired the development of a copper alloy by which superior bendability is obtained while suppressing the growth of the above-described crystal grains.

### SUMMARY OF THE INVENTION

The present invention was made in consideration of the above needs, and it is an object of the present invention to obtain superior strength while suppressing irregularities of wavelengths, etc., of the fluctuations and to provide a copper alloy by which superior bendability is obtained while suppressing growth of crystal grains.

The copper alloy of the present invention is characterized in that the copper alloy is a copper-based alloy containing 2.0 to 4.0 mass % of Ti, and there is contained one or more kinds from Pb, Sn, Zn, Mn, Fe, Co, Ni, S, Si, Al, P, As, Se, Te, Sb, Bi, Au and Ag as an unavoidable impurity elements and any content of these unavoidable impurity elements is not more than 0.01 mass %, and total content of the unavoidable impurity elements is not more than 0.1 mass %, so that not less than 80% of the number of the second-phase particles, which have an area of not less than 0.01 μm² observed by a cross section speculum, containing any one or more kinds of element from among the above-described unavoidable impurity elements at not less than 3% in composition.

Regarding to the cross-section speculum of the present invention, any of the cross-section parallel to the rolling direction or the cross-section transverse to the rolling direction or rolled surface is acceptable. The majority of the second-phase particles are generated during solution treatment, and subsequent reduction ratio of cold rolling is a lower. In an embodiment of the present invention, the rolled surface is subjected to electrolytic polishing as it is, and it was subsequently examined by SEM.

In the present invention, the content of Ti is 2.0 to 4.0 mass %. In the case in which the content of Ti is less than 2.0%, since it is not possible to obtain sufficient strength due to formation of the modulated structure of the original titanium-copper, it is not possible to obtain superior strength of the titanium-copper. In addition, in the case in which the content of Ti is more than 4.0 mass %, TiCu₃ is easily precipitated so as to exhibit strength deterioration and so as to deteriorate bendability. In the present invention, the content of Ti is controlled properly as described above, so that it is possible to obtain both superior strength and bendability. In addition, it is more preferable that, in order to cope with both strength and bendability at a higher level, the content of Ti be 2.5 to 3.5 mass %.

Furthermore, in the present invention, in order to obtain superior strength, the content of the unavoidable impurity elements Pb, Sn, Zn, Mn, Fe, Co, Ni, S, Si, Al, P, As, Se, Te, Sb, Bi, Au and Ag, other than the copper and the titanium, are limited and the composition of the second-phase particle is limited. That is, the total content of the unavoidable impurity elements is made to be not more than 0.1 mass %, and the individual contents of these unavoidable impurity elements is set to be not more than 0.01 mass %, and furthermore, not less than 80% of the number of the second-phase particles, are to be not less than 0.01 μm² area observed in cross section speculum and are made to contain one or more kinds of elements from among the above-described unavoidable impurity elements not less than 3% in composition. The specified elements Pb, Sn, Zn, Mn, Fe, Co, Ni, S, P, As, Se, Te, Sb, Bi, Al, Si, Au and Ag in the present invention are trace elements contained unavoidably in electroplated copper or sponge titanium as a raw material of the titanium-copper, and Si and Al among these are mixed from furnace material are impurity elements. Moreover, the second-phase particle is an area having a boundary with discontinuous composition to matrix, and in the system with the copper and titanium as the principal constituent, the second-phase particles exist as Cu—Ti—X system particles generated in the case of containing unavoidable impurity elements X (Pb, Sn, Zn, Mn, Fe, Co, Ni, S, P, As, Se, Te, Sb, Bi, Al, Si, Au, Ag, etc.). The second-phase particle is also generated depending on crystallization at the time of casting, and the kind of second-phase particle specified by the present invention may be generated when applying annealing during solution treatment or before solution treatment. Here, if the second-phase particle specified by the present invention is generated, the crystal grain diameter after solution treatment is refined, and it is possible to obtain sufficient age-hardenability. In other words, since it is possible to make the content of the above-described element group entered into solid solution within the matrix to be a negligible trace amount, there is no possibility of generating irregularities of wavelength or amplitude of the fluctuations generated within the matrix, so that it is possible to obtain expected age-hardenability and it is possible to obtain excellent strength depending on this age-hardenability. Of course, it is possible to reduce the amounts of these unavoidable impurity elements to further harmless levels by using high grade refining or high grade raw materials while not taking costs into account; however, this is commercially impractical. The present invention is notable in that general raw materials are used, while performing melting casting by conventional methods, and generation of the second-phase particle added in the course of manufacturing process is controlled, whereby, far from sealing in the undesirable influences of these impurity elements in the age-hardening, on the contrary, the impurity elements are utilized; that is, namely, the present invention causes refining crystal grain in the solution treatment, which is difficult to do in conventional techniques.

When the titanium-copper is melted, in the case in which the most common and inexpensive alumina (Al₂O₃) or silica (SiO₂) is used as a furnace material, and Al and Si are deoxidized by the titanium, so that they are dissolved within molten metal. The titanium-copper contains titanium which is extremely strong deoxidizer, and impurity elements are easily mixed from not only raw materials but also furnace materials. However, although the impurity elements are mixed in such a way as described above, if they are controlled in such as specified in the present invention, it is possible to obtain the above described effect, and therefore, it is not necessary to use particularly expensive furnace materials in order to maximally avoid interfusion of the impurity elements.

As indicated above, the present invention is capable of providing copper alloys which have simultaneously both excellent strength and bendability by specifying the content of the Ti and specifying the content of the unavoidable impurity elements and composition of the second-phase particles.

In such copper alloys, it is desirable that the average circular corresponding diameter D observed in cross section be 0.2 to 1.0 μm in second-phase particles having an area of not less than 0.01 μm². Here, the circular corresponding diameter is the diameter of a circle having the same area as the second-phase particle observed in the cross section speculum. In the present invention, the above-described average circular corresponding diameter D is set to be not less than 0.2 μm, so that it is possible to obtain high yield strength by the fact that growth suppressing effects of the above-described crystal grains is sufficiently developed. In addition, since the above-described average circular corresponding diameter D is set to be not more than 1.0 μm, there is prevented deterioration of bendability caused by the fact that grain diameter of the second-phase particle becomes large. Consequently, according to the present invention, it is possible to obtain superior bendability by specifying the average circular corresponding diameter D of the second-phase particle preferably.

Moreover, in such copper alloys, it is desirable that the particle density ρ of the second-phase particles having an area of not less than 0.01 μm² observed by the cross section speculum be (1 to 100) grains/100 μm², and have the average distance of second-phase particle d of 2 to 20 μm defined below.

While paying attention to arbitrary second-phase particles Pi (i=1, 2, . . . , n), the distance from Pi to the second-phase particle Pi1 which is the closest to Pi is defined to be di1, and furthermore, the distance from Pi to the second-phase particle Pi2 which is close to the second to Pi is defined to be di2; that is, the distance from Pi to the second-phase particle Pij which is close to the j-th to Pi is dij. The average distance of second-phase particle d is defined by the following formula. Here, n is a sufficiently large number statistically, such as, for example, at least not less than 10, and Pij is not repeated.

$$d = \frac{1}{n} {\sum }_{i}^{n} ( \frac{1}{10} {{\sum }_{j}}^{10} {d}_{ij} ) = \frac{1}{n} {{\sum }^{n}}_{i} ( \frac{1}{10} {\sum }_{j}^{10} \vert {{P}^{->}}_{ij} - {{P}^{->}}_{i} \vert )$$

The present inventors determined that the state of distribution of the second-phase particle remarkably influences bendability from the results of extensive research concerning various factors related to bendability. First, in the case in which large second-phase particles exists, during bending, stress is concentrated at the points, so that cracks easily occur, and bendability deteriorates. Consequently, in order to obtain superior bendability, it is desirable that the second-phase particles be preferable small. Furthermore, the upper limit value specified by the average corresponding circular diameter is 1 μm. In addition, even though the second-phase particles are small and are not more than 1 μm, if the particle density is high and the average distance of particle d is small, cracks are easily propagated, so that bendability deteriorates, and therefore, the upper limit value of the particle density and lower limit value of the average distance of particle are 100 grains/100 μm² and not less than 2 μm respectively. Furthermore, when applying recrystallization annealing, if the second-phase particle exists, growth of the crystal grain is suppressed; however in the solution treatment of the titanium-copper, if the particle density and the average distance of particle d are not less than 1 grain/100 μm² and not more than 20 μm, respectively, it is possible to expect effects of suppressed growth of the crystal grains. Here, the above defined average distance of particle d is the common statistic which the inventors found during research on the second-phase particles. Generally, in many cases, the average value of the closest distance of particle is used as the average distance of particle. Here, the closest distance of particle is a distance to the closest particle from an arbitrary particle. This value has a problem in that when plural portions to which the particle is tightly-packed partially exist, its value becomes extremely small. Consequently, through improvement on this point, in view of the evaluation of the influence of the existing structure of the second-phase particle to the bendability and grain growth suppressing effect at the time of recrystallization annealing, the average distance of particle d is found to be the statistic accurately reflecting the phenomena. In the present invention, the particle density ρ of the above described second-phase particle is taken to be not less than 1 particle/100 μm², and the above-described average distance of particle d is taken as not being more than 20 μm, so that there is anticipated an effect of suppressing growth of crystal grains by the second-phase particle at the time of the solution treatment. For this reason, it is possible to obtain high yield strength value because fine crystal grains are obtained in spite of the solution treatment conditions at which the titanium solves into matrix sufficiently. In addition, in the present invention, the particle density ρ of the above-described second-phase particle is taken to be not more than 100 grains/100 μm², and the above-described average distance of particle d is taken to be not less than 2 μm, and even though shearing stress is applied to the copper alloy, partial stress concentration is not generated, so that it is possible to obtain excellent bendability. Consequently, according to the present invention, it is possible to obtain extremely excellent bendability by specifying preferably the particle density ρ and the average distance of particle d of the second-phase particle.

### PREFERRED EMBODIMENTS OF THE INVENTION

There will be described copper alloys of the present invention in accordance with its manufacturing process sequentially below. In addition, the manufacturing method comprised of processes shown below is one manufacturing example of the copper alloy of the present invention.

### Ingot Manufacturing Process

With Cu and Ti as raw materials, it is not necessary to use high-grade raw materials with 99.999% purity or more, and thus it is preferable to use regular electroplated copper and sponge titanium specified by Japanese Industrial Standard JIS H 2151, or 1-classification titanium or 2-classification titanium specified by JIS H 4600. Hereby, the amount of unavoidable impurity elements (Pb, Sn, Zn, Mn, Fe, Co, Ni, S, Si, Al, P, As, Se, Te, Sb, Bi, Au, and Ag) contained in these both elements are reduced to within the specified range, and in the later solution treatment process, the amounts of the unavoidable impurity elements which solve into matrix are negligible trace amounts.

Under the above conditions, Cu is subjected to initial melting in a vacuum, and after that, 2.0 to 4.0 mass % of Ti is added. Casting is performed after ascertaining that sufficient melting has occurred.

It is desirable to perform homogenizing annealing not less than one hour at not less than 950° C. after this ingot manufacturing process. By doing this, segregation is reduced, and in the solution treatment described below, it causes precipitation of the second-phase particle to disperse finely and homogeneously, and it is also possible to prevent occurrence of duplex grains structure. Subsequently, hot rolling is performed, and then the solution treatment is performed while repeating the cold rolling and the annealing. The second-phase particle is formed in the annealing process when the annealing temperature is low, and therefore, the annealing is performed at a temperature at which the second-phase particle is completely dissolved. Moreover, in the cold rolling process just before the solution treatment, the higher the reduction ratio, the more the precipitation of the second-phase particle in the solution treatment is homogeneous and fine. In addition, in order to precipitate the fine second-phase particle before the solution treatment, annealing may be performed at low temperatures after the above-described cold rolling; however, only a small effect is obtained, and therefore, it is not advisable in consideration of increase cost because of process increase. When performing low temperature annealing before solution treatment for the above-described object, it is desirable to perform the low temperature annealing at a temperature not more than 450° C. under which Ostwald growth of the second-phase particle will not occur easily.

### Solution Treatment Process

The solution treatment is performed after the above-described cold-rolling process. Here, the point to notice is that it is necessary to heat it up to a temperature (730 to 840° C. within the range of 2 to 4 mass % of Ti addition amount, for example, 800° C. at 3 mass % of Ti addition amount) at which Ti solubility becomes larger than the addition amount. In order to rapidly pass through the temperature range in which TiCu₃ is the easiest to be precipitated, at least up to 600° C., the heating rate should be set to not less than 20° C./sec. According to proper control of this heating rate, it is possible to improve bendability while suppressing precipitation of TiCu₃ to be the stable phase, and it is possible to generate the fine and homogenous second-phase particles in such a manner that the second-phase particles with high suppressing effect against growth of the recrystallization grains, that is, those of the unavoidable impurity elements. Specifically, not less than 80% of the number of the second-phase particles having areas of not less than 0.01 μm² observed by a cross section speculum is made to contain unavoidable impurity elements at not less than 3% in composition. By above treatment, content of the unavoidable impurity elements which enter into solid solution within the matrix can be made to be a negligible trace amount. For this reason, since it is possible to make the content of the above-described unavoidable impurity elements entered into solid solution within the matrix a negligible trace, there is no chance of generating irregularities in wavelength or amplitude of fluctuations generated within the matrix, so that it is possible to obtain expected age-hardenability, and it is possible to obtain excellent strength depending on this age-hardenability.

### Cold-Rolling Process and Aging Treatment Process

The cold-rolling and aging treatment are performed sequentially after the above-described solution treatment. These processes are capable of being performed by normal methods under normal conditions, depending on the application of the copper alloy. For example, when the copper alloy is used as a connector material, etc., regarding the cold-rolling, its reduction ratio of 5 to 50% be applied to the solid solution. In addition, regarding the aging treatment, it is desirable that an aging treatment be performed for 200 min in an inert atmosphere such as Ar gas, etc. at 420° C.

### EMBODIMENTS

Next, embodiments of the present invention will be described.

When for the copper alloy of the present invention, a vacuum melting furnace is used for ingot production in consideration of the fact that active metal Ti is added as the second component, and silica series crucible is used. In addition, in order to prevent interfusion above the specified value of the unavoidable impurity elements specified by the present invention, electroplated copper and 2-classification titanium are used as raw materials.

First, in Embodiments 1 to 10 and Comparative Examples 11 to 20, after initial melting of the electroplated copper in a vacuum, Ar gas is filled in a chamber, and Ti with the compositions as indicated in Table 1 is added. In addition, some of Comparative Examples use in part scrap raw materials with high amounts of impurity elements. After titanium addition, the keeping time after addition is sufficient to produce conditions in which there is no undissolved residues of the added elements, and after that, these are placed in a casting mold in an Ar atmosphere, and then approximately 2 kg ingots were manufactured.

An oxidation inhibitor was applied to the above ingots. After 24 hours of drying at room temperature, hot rolling is applied thereto by heating (homogenization annealing) at 980° C. for 24 hours, so that a hot rolled plate with a thickness of 10 mm was obtained. Next, the oxidation inhibitor was applied again to the hot rolled plate, and then heating at 980° C. for 24 hours for further reducing segregation was applied, and afterwards, water quenching was performed. Here, the reason the oxidation inhibitor is applied is to maximally prevent both grain boundary oxidation and internal oxidation by which inclusions are generated in such a manner as to react oxygen entering from the surface and the added element component. Each hot rolled plate is subjected to cold rolling and annealing repeatedly to have thickness of 0.2 mm after descaling by mechanical grinding and pickling. Afterwards, the rolled material being subjected to cold rolling is inserted into an annealing furnace capable of heating rapidly to heat at various heating rate in Table 1 to 600° C., and finally up to a temperature (800° C. in the case in which addition amount of Ti is 3 mass %) at which Ti solubility becomes larger than the addition amount, and then water quenching is applied thereto after two minutes keeping. On this occasion, average crystal grain size (GS) is measured by an intercept method. Afterwards, there is obtained a rolled material with a thickness of 0.14 mm while applying cold rolling after pickling. Test pieces of respective Embodiments and Comparative Examples are formed in such a manner as to heat the rolled material described above at 420° C. for 3 hours within an inert gas atmosphere. Table 1 shows wet quantitative analysis value of the test pieces of these Embodiments 1 to 10 and Comparative Examples 11 to 20. In addition, with respect to units concerning indicated values in Table 1, Ti is mass %, and the rest are in ppm.

TABLE 1

| | No. | Ti | Pb | Sn | Zn | Mn | Fe | Co | Ni | S | Si | Al | P | As | Se | Te |
|---|---|---|---|---|---|---|---|---|---|---|---|---|---|---|---|---|
| Embodiment | 1 | 2.4 | 0.23 | 2.1 | 5.1 | 2.4 | 14 | 0.23 | 8.1 | 5.33 | 12 | 26 | 0.44 | 2.2 | 0.53 | 0.24 |
| | 2 | 2.3 | 0.30 | 2.6 | 10.1 | 4.5 | 21.8 | 0.38 | 10.9 | 8.3 | 19 | 28 | 0.50 | 3.7 | 0.98 | 0.37 |
| | 3 | 3.6 | 0.47 | 4.3 | 14.9 | 5.6 | 32.7 | 0.56 | 16.3 | 11.2 | 27 | 54 | 0.96 | 6.8 | 1.29 | 0.62 |
| | 4 | 3.1 | 0.71 | 6.6 | 22.1 | 9.9 | 36.5 | 0.93 | 23.1 | 13.1 | 55 | 68 | 1.23 | 8.6 | 1.96 | 0.77 |
| | 5 | 3.2 | 1.09 | 12.0 | 31.8 | 10.7 | 62.2 | 1.68 | 26.1 | 20.3 | 55 | 114 | 2.17 | 15.5 | 3.24 | 1.06 |
| | 6 | 2.7 | 0.44 | 3.8 | 9.8 | 3.8 | 24.7 | 0.27 | 14.3 | 9.2 | 21 | 41 | 0.65 | 4.1 | 0.96 | 0.44 |
| | 7 | 3.3 | 0.37 | 2.7 | 7.4 | 4.3 | 17.9 | 0.24 | 14.8 | 6.6 | 17 | 32 | 0.50 | 2.4 | 0.85 | 0.40 |
| | 8 | 2.9 | 0.27 | 3.0 | 8.1 | 4.3 | 26.2 | 0.28 | 8.7 | 5.9 | 21 | 30 | 0.46 | 2.5 | 0.60 | 0.39 |
| | 9 | 3.2 | 0.43 | 2.6 | 8.6 | 2.4 | 18.6 | 0.31 | 8.9 | 7.1 | 20 | 41 | 0.55 | 3.6 | 0.78 | 0.30 |
| | 10 | 3.0 | 0.40 | 3.3 | 9.3 | 3.3 | 21.7 | 0.37 | 12.9 | 8.4 | 18 | 28 | 0.56 | 2.7 | 0.54 | 0.45 |
| Comparative | 11 | 2.5 | 0.3 | 11 | 20 | 850 | 49 | 23.6 | 30 | 186 | 210 | 120 | 0.7 | 4.2 | 3.0 | 1.0 |
| Examples | 12 | 3.0 | 0.3 | 3.2 | 12 | 950 | 45 | 35.5 | 44 | 190 | 350 | 180 | 1.5 | 13 | 2.0 | 1.0 |
| | 13 | 3.0 | 0.2 | 2.6 | 4.9 | 1.6 | 19 | 0.2 | 4.9 | 2.7 | 17 | 19 | 0.4 | 2.4 | 0.5 | 0.2 |
| | 14 | 3.0 | 0.2 | 3.3 | 11 | 3.4 | 28 | 0.3 | 15 | 6.4 | 15 | 15 | 0.5 | 4.6 | 1.1 | 0.4 |
| | 15 | 3.0 | 0.4 | 2.2 | 14 | 4.9 | 19 | 0.5 | 20 | 8 | 28 | 41 | 0.5 | 9.9 | 1.6 | 0.5 |
| | 16 | 3.0 | 0.6 | 6.3 | 18 | 14 | 23 | 1 | 16 | 15 | 78 | 61 | 1.6 | 12 | 2.1 | 1 |
| | 17 | 2.9 | 0.7 | 7.5 | 20 | 6.2 | 90 | 1.9 | 38 | 26 | 63 | 140 | 1.7 | 9.5 | 3.9 | 1.4 |
| | 18 | 2.8 | 0.3 | 4.2 | 7.7 | 2.8 | 26 | 0.3 | 17 | 11 | 17 | 31 | 0.7 | 3.5 | 0.6 | 0.6 |
| | 19 | 3.1 | 0.5 | 3.2 | 9.1 | 6.4 | 17 | 0.2 | 15 | 4.4 | 19 | 44 | 0.4 | 1.2 | 0.6 | 0.2 |
| | 20 | 3.2 | 0.3 | 3.4 | 8.2 | 2.8 | 19 | 0.4 | 13 | 3.3 | 12 | 39 | 0.3 | 2.6 | 0.6 | 0.5 |

| | | | | | | | Heating |
|---|---|---|---|---|---|---|---|
| | No. | Sb | Bi | Au | Ag | Cu | Rate (° C./sec) |
| Embodiment | 1 | 0.52 | 0.10 | 0.10 | 11 | Remainder | 50 |
| | 2 | 0.87 | 0.12 | 0.13 | 15.5 | Remainder | 50 |
| | 3 | 1.53 | 0.18 | 0.20 | 21.2 | Remainder | 50 |
| | 4 | 2.24 | 0.26 | 0.30 | 33.8 | Remainder | 50 |
| | 5 | 4.12 | 0.40 | 0.42 | 41.9 | Remainder | 50 |
| | 6 | 0.84 | 0.11 | 0.14 | 15.1 | Remainder | 50 |
| | 7 | 0.76 | 0.16 | 0.11 | 13.7 | Remainder | 50 |
| | 8 | 0.58 | 0.16 | 0.16 | 16.3 | Remainder | 50 |
| | 9 | 0.66 | 0.15 | 0.19 | 20.5 | Remainder | 50 |
| | 10 | 0.97 | 0.12 | 0.15 | 18.9 | Remainder | 50 |
| Comparative | 11 | 2.3 | 0.7 | 0.17 | 9.6 | Remainder | 50 |
| Examples | 12 | 2.7 | 1.0 | 0.13 | 10.6 | Remainder | 50 |
| | 13 | 0.5 | 0.1 | 0.1 | 7.2 | Remainder | 10 |
| | 14 | 0.8 | 0.1 | 0.1 | 15 | Remainder | 5 |
| | 15 | 2.2 | 0.1 | 0.3 | 27 | Remainder | 50 |
| | 16 | 2.6 | 0.2 | 0.3 | 18 | Remainder | 50 |
| | 17 | 4.8 | 0.4 | 0.4 | 29 | Remainder | 50 |
| | 18 | 0.7 | 0.1 | 0.1 | 21 | Remainder | 50 |
| | 19 | 1.1 | 0.1 | 0.1 | 18 | Remainder | 50 |
| | 20 | 0.6 | 0.2 | 0.1 | 9.9 | Remainder | 50 |

Next, in the Embodiments and Comparative Examples, respective effectiveness of the Embodiment is verified in such a way as to measure 0.2% yield strengths, and MBR/t values while performing W bending tests. Here, the MBR/t value is the ratio between minimum bending radius (MBR) at which cracking is not generated and the thickness (t). Here, the MBR/t value indicates that the smaller the value, the greater the superiority in bendability. Moreover, as to the evaluation of the second-phase particles, all compositions of the second-phase particles of length not less than 0.1 μm existing in a unit area is measured by field-emission type Auger electron spectroscopy (FE-AES), and then the corresponding circular diameters of the second-phase particles are obtained by the image analysis apparatus, and the second-phase particles to be not less than 0.01 μm² area is made an object, followed by obtaining average circular corresponding diameter (D), particle density (ρ) and average distance of particle (d). Then there is obtained the ratio of the second-phase particle to be not less than 3% in composition of the unavoidable impurity elements. This value is taken to be a value A(%) as a matter of convenience. In addition, measurement field of view is 100 μm×100 μm. It is indicated that the higher the value A, the more the unavoidable impurity elements are contained in the second-phase particles in comparison with the matrix, so that the copper alloy indicates excellent strength. Here, the corresponding circular diameter is the diameter of the circle which has the same area as the second-phase particle observed by the cross section speculum. Table 2 shows each average circular corresponding diameter (D), particle density (ρ), and average distance of particle (d), grain size (GS), 0.2% yield strength (MPa), and MBR/t value of the Embodiments and Comparative Examples.

TABLE 2

| | | | | | | | 0.2% yeild | |
|---|---|---|---|---|---|---|---|---|
| | | | | | | | strength | |
| | No. | Value A (%) | D (μm) | ρ (particles/μm²) | d (μm) | GS (μm) | (MPa) | MBR/t |
| Embodiment | 1 | 85 | 0.55 | 2 | 18 | 15 | 802 | 1.7 |
| | 2 | 87 | 0.40 | 5 | 15 | 12 | 803 | 1.7 |
| | 3 | 90 | 0.73 | 26 | 8.5 | 9.2 | 830 | 1.9 |
| | 4 | 88 | 0.81 | 15 | 9.2 | 10.8 | 825 | 1.8 |
| | 5 | 83 | 0.66 | 30 | 8.0 | 8.6 | 836 | 2.0 |
| | 6 | 93 | 0.36 | 35 | 6.5 | 8.3 | 838 | 2.0 |
| | 7 | 89 | 0.35 | 40 | 4.7 | 8.0 | 823 | 1.7 |
| | 8 | 96 | 0.23 | 60 | 3.5 | 7.8 | 822 | 1.7 |
| | 9 | 98 | 0.22 | 70 | 2.7 | 7.2 | 836 | 1.7 |
| | 10 | 97 | 0.21 | 80 | 2.3 | 7.0 | 839 | 1.7 |
| Comparative | 11 | 85 | 0.55 | 2 | 18 | 15 | 732 | 2.0 |
| Example | 12 | 88 | 0.40 | 5 | 15 | 12 | 733 | 2.0 |
| | 13 | 67 | 0.73 | 26 | 8.5 | 9.2 | 750 | 3.5 |
| | 14 | 55 | 0.81 | 15 | 9.2 | 10.8 | 755 | 4.0 |
| | 15 | 83 | 2.12 | 30 | 8.0 | 8.6 | 836 | 4.0 |
| | 16 | 93 | 0.02 | 35 | 6.5 | 28.3 | 788 | 2.0 |
| | 17 | 89 | 0.35 | 0.7 | 19.5 | 29.0 | 773 | 1.7 |
| | 18 | 96 | 0.23 | 180 | 2.2 | 20.2 | 798 | 2.5 |
| | 19 | 98 | 0.22 | 90 | 1.5 | 21.8 | 795 | 2.5 |
| | 20 | 97 | 0.21 | 1.2 | 22.3 | 27.5 | 779 | 1.7 |

As seen in Table 2, in the Embodiments, in all cases, the 0.2% yield strength is not less than 800 MPa, and the MBR/t value is not more than 2.0, and this shows that excellent strength and bendability are obtained simultaneously.

On the other hand, in the Comparative Examples, the 0.2% yield strength is less than 800 MPa, or the MBR/t values exceed 2.0, and this shows that excellent strength and bendability are not obtained simultaneously. Specifically, in the Comparative Examples No. 11 and No. 12, since the content of the unavoidable impurity elements exceeds the specified values, there occur irregularities in wavelengths or amplitudes which are a primary factor of the modulated structure, so that age-hardenability deteriorates. For this reason, strength improvement is not achieved, and therefore sufficient 0.2% yield strength is not obtained. In the Comparative Examples No. 13 and No. 14, the heating rate of the solution treatment is made small in comparison with other examples, and therefore, the value A is smaller than the specified value, and conversely, the precipitation amount of TiCu₃ is large, so that bendability deteriorates and age hardening amount is small, and accordingly, sufficient 0.2% yield strength is not obtained. In the Comparative Example No. 15, final aging treatment is performed at a temperature higher than 450° C., therefore, Ostwald growth of the second-phase particles occurs, and the average corresponding circular diameter D becomes larger than the specified value, so that excellent bendability is not obtained. In the Comparative Example No. 16, the present Embodiment No. 10 whose Ti addition amount is 3 mass % is subjected to the solution treatment at 800° C., and in contrast, the Comparative Example No. 16 whose Ti addition amount is the same as the Embodiment No. 10 is subjected to the solution treatment at a higher temperature (870° C.) than is necessary, and therefore, the precipitation amount of the second-phase particles is reduced, and the average corresponding circular diameter D is smaller than the specified value, so that the crystal grain size (GS) after solution treatment becomes remarkably large, and thus sufficient 0.2% yield strength is not obtained. In the Comparative Examples No. 17 and No. 20, which are subjected to solution treatment without being subjected to sufficient reduction ratio of previous cold-rolling, therefore, in the former case, the particle density ρ of the second-phase particles is made smaller than the specified value, and in the latter case, the average distance of particle d of the second-phase particle is made larger than the specified value. In this way, in both cases, the crystal grain size (GS) after solution treatment becomes remarkably large, so that sufficient 0.2% yield strength is not obtained. In the Comparative Examples No. 18 and No. 19, which are subjected to the solution treatment for relatively long period, the crystal grains grow, so that sufficient 0.2% yield strength is not obtained. Furthermore, in the former case, the particle density ρ of the second-phase particles is larger than the specified value, and in the latter case, the average distance of particle d of the second-phase particle becomes smaller than the specified value. For this reason, in both cases, when applying shearing stress, partial stress concentration occurs, so that it is not possible to obtain excellent bendability.

What is claimed is:

1. A copper alloy comprising:
2.0 to 4.0 mass % of Ti;
not more than 0.1 mass % in total of unavoidable impurity elements consisting of Pb, Sn, Zn, Mn, Fe, Co, Ni, S, Si, Al, P, As, Se, Te, Sb, Bi, Au, and Ag, each unavoidable impurity element being contained at not more than 0.01 mass %; and
second-phase particles represented by Cu—Ti—X system particles, wherein X is selected from the group consisting of Pb, Sn, Zn, Mn, Fe, Co, Ni, S, Si, Al, P, As, Se, Te, Sb, Bi, Au, and Ag;
wherein the second-phase particles have an area of not less than 0.01 μm² observed by a cross section speculum, and not less than 80% of the number of the second-phase particles contain not less than 3% in total amount of the unavoidable impurity elements in composition.

2. The copper alloy according to claim 1, wherein when the second-phase particles of not less than 0.01 μm² area observed by a cross section speculum is assumed to be a circle having a diameter of D, the diameter D is 0.2 to 1.0 μm.

3. The copper alloy according to claim 1, wherein the second-phase particle has:
a particle density ρ, of second-phase particles of area of not less than 0.01 μm² observed by the cross section speculum, is 1 to 100 particles per 100 μm²; and
an average distance of particles d defined by the following formula, wherein the average distance of particles d is 2 to 20 μm
$$d = \frac{1}{n} {\sum }_{i}^{n} ( \frac{1}{10} {\sum }_{j}^{10} {d}_{ij} ) = \frac{1}{n} {\sum }_{i}^{n} ( \frac{1}{10} {\sum }_{j}^{10} \vert {{P}^{->}}_{ij} - {{P}^{->}}_{i} \vert )$$
di1: distance from arbitrary second-phase particle Pi (i=1, 2, . . . , n) to the second-phase particle Pi1 which is the closest to Pi
di2: distance from Pi to the second-phase particle Pi2 which is close to the second to Pi
dij (no repetition): distance from Pi to the second-phase particle Pij which is close to the j-th to Pi
d: average distance of particles (above formula)
n: sufficiently large number, statistically of at least 10.
